(19) United States
(12) Patent Application Publication
(10) Pub. No.: US 2026/0290732 A1
(43) Pub. Date: Sep. 24, 2026

(54) ADAPTIVE FUSE SYSTEM

(71) Applicant: Lear Corporation, Southfield, MI (US)

(72) Inventors: Antoni Pujol Simon, Valls (ES); Josep Jacas Miret, Valls (ES)

(21) Appl. No.: 19/086,888

(22) Filed: Mar. 21, 2025

(51) Int. Cl. H01H 39/00; B60L 3/04; B60L 53/10; B60L 53/62; H02J 1/08

(52) U.S. Cl. CPC H01H 39/006; B60L 3/04; B60L 53/11; B60L 53/62; H02J 1/084; B60L 2260/20

(57) ABSTRACT

An electrical system includes a pyro switch, a controller, and a plurality of loads. The pyro switch may include an adaptive current threshold adjustable between at least one of a first current value associated with a first driving mode and a second current value associated with a second driving mode. The controller may be communicatively connected with the pyro switch; and the plurality of loads may be connected with the pyro switch. The controller may be configured to adjust the adaptive current threshold of the pyro switch in response to a sensed driving mode of a load of the plurality of loads. The electrical system may further comprise a current sensor connected to the plurality of loads, wherein the controller receives current information from the current sensor.

### TECHNICAL FIELD

The present disclosure generally relates to an adaptive fuse system, including adaptive fuse systems that may, for example, include an adjustable current threshold value for managing one or more selectively connected loads.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a block system diagram generally illustrating an embodiment of an adaptive fuse system according to teachings of the present disclosure.

FIG. 2A is a block system diagram generally illustrating an embodiment of an adaptive fuse system with a controller disposed within a pyro switch according to teachings of the present disclosure.

FIG. 2B is a block system diagram generally illustrating an embodiment of an adaptive fuse system with a controller disposed external to a pyro switch according to teachings of the present disclosure.

FIG. 3 is a block system diagram generally illustrating an embodiment of an adaptive fuse system according to teachings of the present disclosure.

FIG. 4 is a block system diagram generally illustrating an embodiment of an adaptive fuse system according to teachings of the present disclosure.

FIG. 5 is a flow diagram generally illustrating an embodiment of a method of operating an adaptive fuse system according to teachings of the present disclosure.

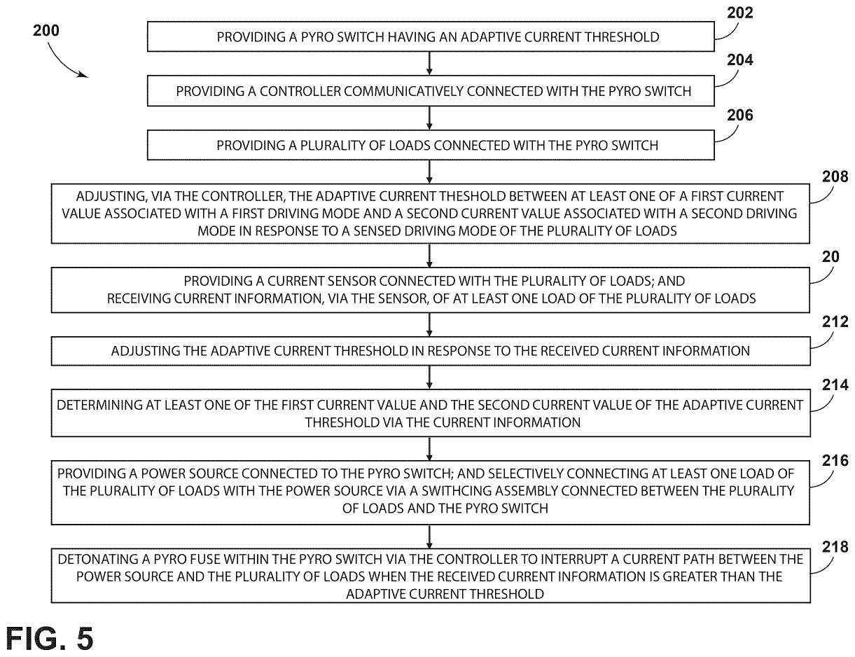

### DETAILED DESCRIPTION

Reference will now be made in detail to embodiments of the present disclosure, examples of which are described herein and illustrated in the accompanying drawings. While the present disclosure will be described in conjunction with embodiments and/or examples, they do not limit the present disclosure to these embodiments and/or examples. On the contrary, the present disclosure covers alternatives, modifications, and equivalents.

In embodiments, it can be desired to manage power distribution and protection with a variety of circuits and/or over current protection components. Passive fuses may be used in such power distribution and protection circuits to protect against over currents; however, passive fuses include limitations when managing a plurality of loads in different power branches. For example, an adaptive pyro switching system may be configured to manage a plurality of loads in a dynamic manner.

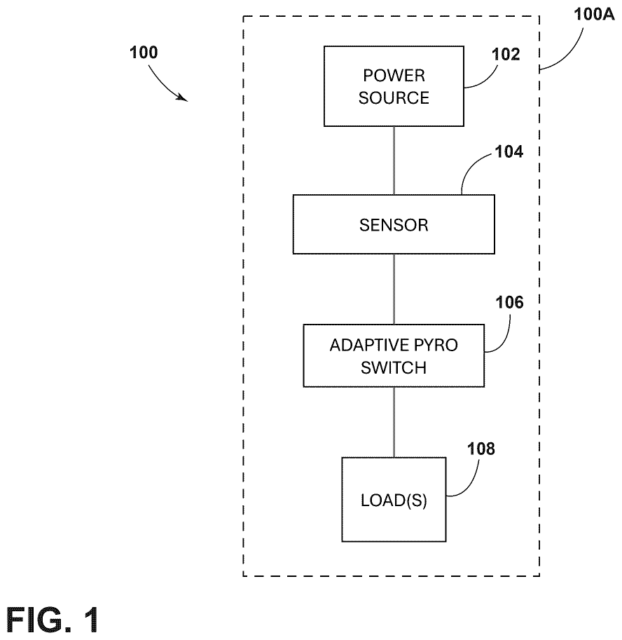

With embodiments, such as generally illustrated in FIG. 1, an adaptive fuse system 100 may include a power source 102, a sensor 104, an adaptive pyro switch 106, and/or one or more loads 108. As shown, the power source 102, the sensor 104, the adaptive pyro switch 106, and/or the one or more loads 108 may be connected in series, with the one or more loads 108 connected in a parallel configuration. The adaptive fuse system 100 may be configured for use with high-voltage power distribution and/or low-voltage power distribution due to the adaptive nature. For example, low-voltage power distribution may include 12 VC for standard automotive electrical systems and/or 24 VDC for commercial vehicles and heavy-duty applications. In further examples, high-voltage power distribution may include: up to about 400 VDC for electric and/or hybrid vehicles; up to about 1,000 VDC for advanced electric vehicles, eVTOL aircraft, and high-power battery systems; and/or greater than 1,000 VDC for specialized high-power applications. The adaptive fuse system 100 may be configured for managing and/or routing high currents from about 400 A to about 700 A (e.g., or more or less depending on the particular application).

Additionally, the adaptive fuse system 100 may be used in connection with a vehicle system 100A, which may be connected to one or more of a variety of other vehicle-related systems. Further, the one or more loads 108 may be driving modes of the vehicle system 100A; such as, a charging mode and/or an air braking mode, among other modes. The adaptive fuse system 100 may be operable to determine a driving mode of the vehicle system 100A, and/or the adaptive fuse system 100 may adjust an adaptive current threshold to protect/manage the connected load of the one or more loads 108.

In examples, the power source 102 (e.g., a battery) may be connected with the adaptive pyro switch 106 in a series configuration. Further, the sensor 104 (e.g., current sensor) may be connected in series between the power source 102 and the adaptive pyro switch 106. The sensor 104 may be a shunt device and/or a hall effect device, among other current sensing components/devices. The sensor 104 may be configured to measure a current through the adaptive fuse system 100 (and/or other connected systems) and/or may be communicatively connected with the one or more controllers/programmable circuit boards. The adaptive pyro switch 106 may include an adaptive current threshold (e.g., for a controller to adjust/determine) so that the plurality of loads 108 may be selectively connected with the power source 102 with varying current thresholds. In such a manner, the adaptive pyro switch 106 may adapt/change the detonating threshold of a pyro fuse to align with a current profile of a connected load 108 (e.g., which may be determined via a connected controller and/or the sensor 104). Further, the adaptive pyro switch 106 may be configured for protecting a connected load of the one or more loads 108 in abnormal conditions, where measured current exceeds the over current threshold.

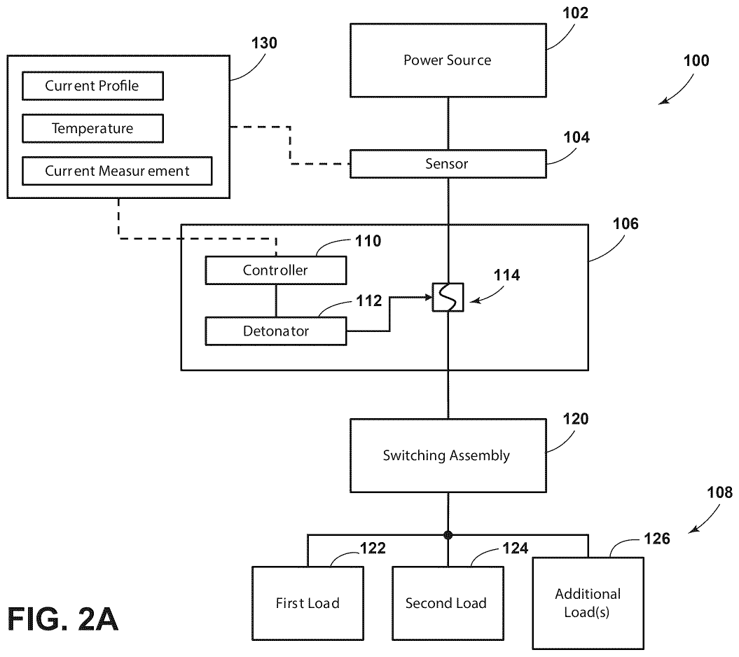

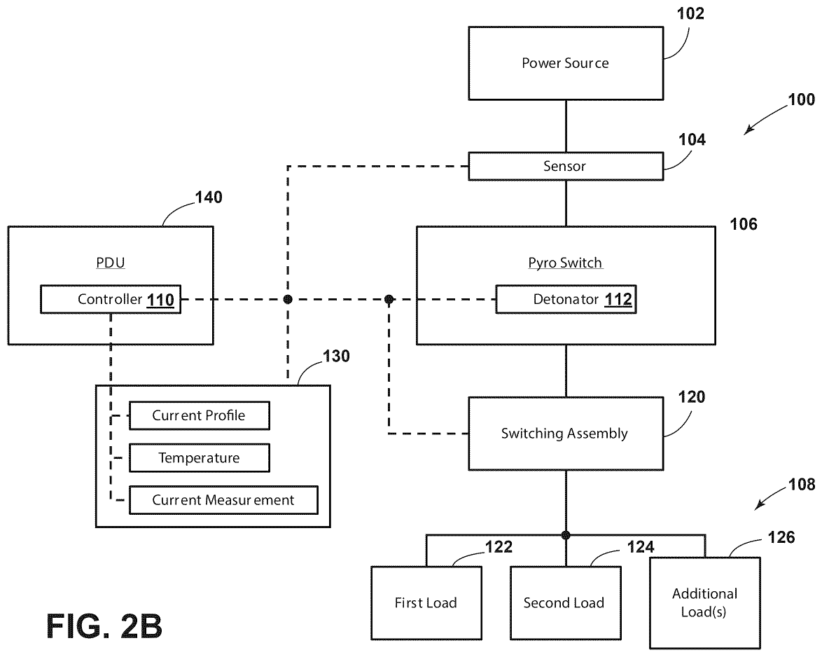

Turning to FIG. 2A, the adaptive pyro switch 106 is shown in further detail. For example, the adaptive pyro switch 106 may include the controller 110, a detonator 112, and/or a pyrotechnic charge 114. The controller 110 may be communicatively connected with the sensor 104, detonator 112, and/or the pyrotechnic charge 114. The controller 110 may be operable to receive information from connected sources (e.g., the sensor 104, the detonator 112, and/or a switching assembly 120). The controller 110 may include and/or be connected with a programmable circuit board (PCB) which may be configured to operate the detonator 112. Generally, the controller 110 may determine an operating mode of the adaptive fuse system 100 based on a connected load of the one or more loads 108 (e.g., via the switching assembly 120). Further, the controller 110 may adjust an adaptive current threshold of the detonator 112 (e.g., the adaptive pyro switch 106) based on the connected load of the one or more loads 108. Activating the detonator 112 may break the connection at the pyrotechnic charge 114 thereby disconnecting the one or more loads 108 from the power source 102. For example, the controller 110 may determine whether a threshold current value has been exceeded, and/or the controller 110 may transmit a signal to the detonator 112 to break the current path from the power source 102 to the one or more loads 108 (e.g., to limit damage to the one or more loads 108 from high-currents).

In examples, the one or more loads 108 may include a first load 122, a second load 124, and/or any number of additional loads 126. The controller 110 may be operable to determine an adaptive current threshold (e.g., a maximum safe current) of the connected load of the one or more loads 108; and/or the controller 110 may be operable to adjust the adaptive current threshold to protect against over currents for each of the connected loads 108 (e.g., which may be different driving modes of an electric vehicle). With embodiments, the one or more loads 108 of the adaptive fuse system 100 may operate non-simultaneously. For example and without limitation, if the first load 122 of the one or more loads 108 is connected to the power source 102 via the switching assembly 120, the second load 124 and/or the additional loads 126 may not be connected to the power source 102 (e.g., and thus, may not be operable). If the second load 124 of the one or more loads 108 is connected to the power source 102 via the switching assembly 120, the first load 122 and/or the additional loads 126 may not be connected to the power source 102 (e.g., and thus, may not be activatable). Examples of non-simultaneous loads may include but may not be limited to: a charging system and a driving motor load; a high-voltage heating system (e.g., for cabin heating) and a battery cooling system (e.g., for battery thermal management); and/or a regenerative braking system and a propulsion system for the associated vehicle.

With embodiments, the controller 110 may be configured to receive current information 130 from the sensor 104 in determining the adaptive current threshold for the adaptive pyro switch 106. Current information 130 provided by the sensor 104 may include a current profile (e.g., a current measurement among other information) of the connected load of the one or more loads 108 and/or a temperature measurement. The controller 110 and/or the detonator 112 may be disposed within the adaptive pyro switch 106 (e.g., a pyro switch assembly/housing) as shown in FIG. 2A. In further examples, as shown in FIG. 2B, the controller 110 may be disposed external to the adaptive pyro switch 106 and/or the controller 110 may be disposed within a power distribution unit (PDU) 140. The controller 110 may transmit and/or receive information from the sensor 104, the detonator 112, the switching assembly 120, and/or the one or more loads 108.

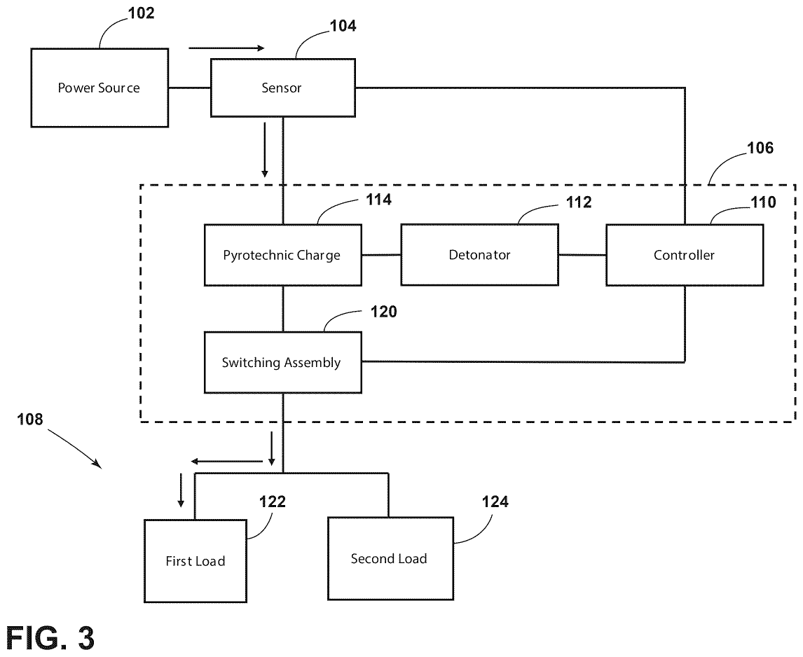

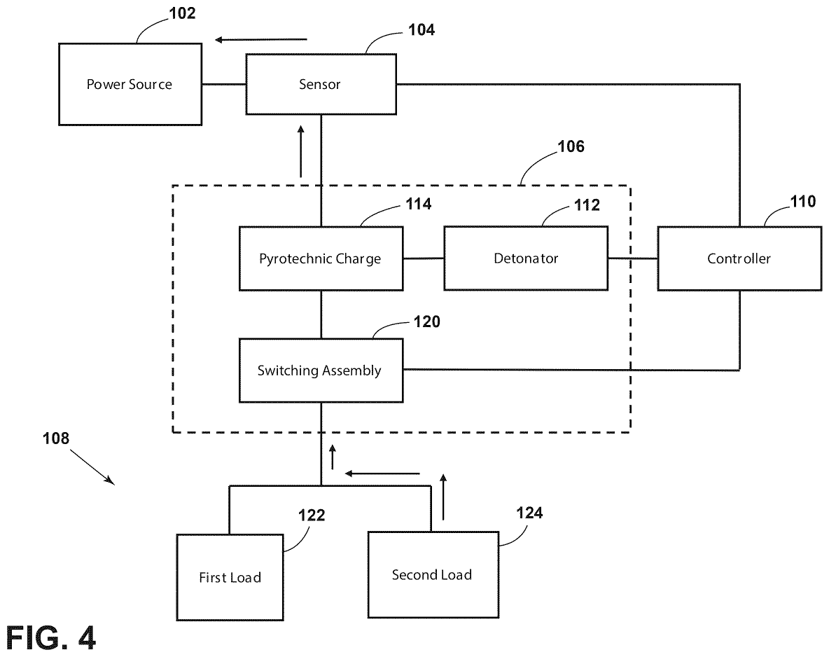

In further embodiments, such as illustrated in FIGS. 3 and 4, the controller 110 may be connected (e.g., communicatively) to the sensor 104, the detonator 112, and/or the switching assembly 120 such that the controller 110 may receive information from a plurality of sources within the adaptive fuse system 100 in selecting the adaptive current threshold. The controller 110 may be operable to receive information from: a user occupying a vehicle (e.g., an input interface such as a cluster may receive a command); the switching assembly 120 (e.g., indicating the connected load of the plurality of loads 108); the controller 110; and/or the PDU 140.

With embodiments, the controller 110 may be operable to determine the operating mode of the adaptive fuse system 100 (e.g., of the connected vehicle system 100A). Further, the controller 110 may receive information from the switching assembly 120 (e.g., a position of the switch) indicating the connected load of the plurality of loads 108 (e.g., which may indicate a driving mode). For example, a user/operator of the vehicle system 100A may input a desired command (e.g., via a switch) that may be received via the controller 110. The controller 110 may communicate with the adaptive pyro switch 106 to set the desired current threshold, which may include selecting a first current threshold corresponding with the first load 122; a second current threshold corresponding with the second load 124; and/or any number of additional current thresholds corresponding with the one or more additional loads 126).

In examples, the switching assembly 120 may be connected between the adaptive pyro switch 106 and/or the plurality of loads 108; and further, the switching assembly 120 may connect one or more loads of the plurality of loads 108 with the pyrotechnic charge 114. The switching assembly 120 may include one or more of a variety of embodiments. For example and without limitation, the switching assembly 120 may be disposed external to the adaptive pyro switch 106 as shown in FIGS. 2A and 2B. In alternative embodiments, the switching assembly 120 may be disposed at least partially within the adaptive pyro switch 106 as shown in FIGS. 3 and 4. The switching assembly 120 may include one or more switches to facilitate connecting and/or disconnecting the one or more loads 108 with the power source 102, which may be at the direction of the controller 110. In additional embodiments, the switching assembly 120 may include one or more additional switches for selectively connecting the plurality of loads 108, which may be disposed between each of the plurality of loads 108. In additional embodiments, a single load of the plurality of loads 108 may be connected with a switch of the switching assembly 120, while other load(s) may not be connected with the switching assembly 120.

With embodiments, as generally shown in FIG. 3, the one or more loads 108 of the adaptive fuse system 100 may include an air brake mode (e.g., the first load 122) and/or a fast charging mode (e.g., the second load 124). The adaptive fuse system 100 may operate in a first mode (e.g., as indicated via directional arrows) where the first load 122 may be connected with the power source 102 and the second load 124 may be disconnected from the power source 102. In such a manner, the second load 124 may not be operable while the first load 122 is connected with the power source 102. In examples, where the first load 122 is connected to the power source 102, the second load 124 may not generally involve a vehicle safety function, as the loads 108 are connected non-simultaneously with the power source 102.

As shown via the directional arrows of FIG. 3, the first load 122 (e.g., the air brake mode) may be selectively connected with the power source 102. The first load 122 (e.g., the air brake mode) may receive power from the power source 102 to activate/engage an associated air brake system of the vehicle system 100A. The controller 110 may receive information indicating a desired load (e.g., the first load 122) to be connected with the power source 102, for example, via the switching assembly 120 and/or the sensor 104. In response to receiving information, the controller 110 may determine a first current threshold for the pyrotechnic charge 114 of the adaptive pyro switch 106 associated with operation of the air brake load (e.g., the first load 122). The controller 110 may set (e.g., program and/or adjust) the first current threshold of the adaptive pyro switch 106 to about 350 A or more or less. Therefore, for currents in the adaptive fuse system 100 greater than the first current threshold, the controller 110 may activate the detonator (e.g., trigger, ignite, etc.) to disconnect the first load 122 from the power source 102.

In examples, as generally illustrated in FIG. 4, the adaptive fuse system 100 may operate in a second mode (e.g., as indicated via directional arrows) where the second load 124 may be connected with the power source 102 and the first load 122 may be disconnected from the power source 102. In such a manner, the first load 122 may not be operable while the second load 124 is connected with the power source 102. Further, the second mode may include connecting the vehicle system 100A (e.g., the power source 102 on board a vehicle) to an external power supply, such as a charging station.

With embodiments, the controller 110 may receive information via the sensor 104 and/or the switching assembly 120 indicating a desired load (e.g., the second load 124) to be connected with the power source 102. In response to receiving such information, the controller 110 may determine a second current threshold for the detonator 112 of the adaptive pyro switch 106 associated with operation of the fast charging load (e.g., the second load 124). The controller 110 may set (e.g., program and/or adjust) the second current threshold of the adaptive pyro switch 106 to about 700 A or more or less. Therefore, for currents in the adaptive fuse system 100 greater than the second current threshold, the detonator 112 may activate (e.g., trigger, ignite, etc.) to disconnect the second load 124 from the power source 102.

In examples, a method 200 of operating an adaptive fuse system 100 may include providing an adaptive pyro switch 106 having an adaptive current threshold (step 202); and/or providing a controller 110 communicatively connected with the adaptive pyro switch 106 (step 204). Additionally, the method 200 may include providing a plurality of loads 108 connected with the adaptive pyro switch 106 (e.g., selectively connected) (step 206). The method 200 may include adjusting, via the controller 110, the adaptive current threshold between at least one of a first current value associated with a first driving mode and/or a second current value associated with a second driving mode in response to a sensed driving mode of the plurality of loads 108 (step 208).

With embodiments, the method 200 may include providing a current sensor 104 connected to the plurality of loads 108 and/or receiving current information from the current sensor 104 via the controller 110. Further, the current information may be a current profile of the active load of the plurality of loads 108. Additionally, the method 200 may include determining a value of the first current threshold and/or a second current threshold via the controller 110 (e.g., information received by the controller 110). The plurality of loads 108 may correspond with a plurality of driving modes for a vehicle system 100A connected with the adaptive pyro switch 106.

In embodiments, the method 200 may include providing a current sensor 104 connected to the plurality of loads 108, and/or the method 200 may further include receiving current information 130, via the current sensor 104, of at least one load of the plurality of loads 108 (step 210). The method 200 may include adjusting the adaptive current threshold in response to the received current information 130 (step 212). In embodiments, the method 200 may include determining at least one of the first current value and the second current value of the adaptive current threshold via the current information 130 (step 214). Further, the method 200 may include providing a power source 102 connected to the adaptive pyro switch 106; and/or selectively connecting at least one load of the plurality of loads 108 with the power source 102 via a switching assembly connected between the plurality of loads 108 and the adaptive pyro switch 106 (step 216). Additionally, the method 200 may include detonating a pyrotechnic charge within the adaptive pyro switch 106 via the controller 110 to interrupt a current path between the power source 102 and the plurality of loads 108 when the received current information is greater than the adaptive current threshold (step 218).

In examples, a controller (e.g., the controller 110) may include an electronic controller and/or include an electronic processor, such as a programmable microprocessor and/or microcontroller. In embodiments, a controller may include, for example, an application specific integrated circuit (ASIC). A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

The disclosure includes, without limitation, the following embodiments:
1. An electrical system, comprising: a pyro switch including an adaptive current threshold, the adaptive current threshold adjustable between at least one of a first current value associated with a first driving mode and a second current value associated with a second driving mode; a controller communicatively connected with the pyro switch; and a plurality of loads connected with the pyro switch; wherein the controller is operable to adjust the adaptive current threshold of the pyro switch in response to a sensed driving mode of a load of the plurality of loads.
2. The electrical system of embodiment 1, wherein the adaptive current threshold of the pyro switch is a current limit of an active load of the plurality of loads.
3. The electrical system according to any of the preceding embodiments, further comprising a current sensor connected to the controller and the pyro switch; wherein the controller receives current information from the current sensor.
4. The electrical system according to any of the preceding embodiments, wherein the controller determines the adaptive current threshold of the pyro switch via the current information.
5. The electrical system according to any of the preceding embodiments, wherein the current information is a current profile of an active load of the plurality of loads.
6. The electrical system according to any of the preceding embodiments, wherein the first driving mode is associated with a fast-charging mode.
7. The electrical system according to any of the preceding embodiments, wherein the first current value is about 700 A.
8. The electrical system according to any of the preceding embodiments, wherein the second driving mode is associated with an air brake mode.
9. The electrical system according to any of the preceding embodiments, wherein the second current value is about 350 A.
10. The electrical system according to any of the preceding embodiments, further comprising a power source connected with the pyro switch; wherein the power source selectively supplies power to the plurality of loads via the pyro switch operated by the controller.
11. The electrical system according to any of the preceding embodiments, further comprising a switch assembly connected between the pyro switch and the plurality of loads; wherein the switch assembly includes at least one switch; and the switch assembly selectively connects at least one load of the plurality of loads with the pyro switch.
12. The electrical system according to any of the preceding embodiments, wherein the controller is operable to control the switch assembly; and the controller selectively connects the plurality of loads with the power source.
13. A method of adjusting a current threshold, the method comprising: providing a pyro switch having an adaptive current threshold; providing a controller communicatively connected with the pyro switch; providing a plurality of loads connected with the pyro switch; and adjusting, via the controller, the adaptive current threshold between at least one of a first current value associated with a first driving mode and a second current value associated with a second driving mode in response to connecting at least one load of the plurality of loads with the pyro switch.
14. The method according to any of the preceding embodiments, further comprising: providing a current sensor connected with the plurality of loads; and receiving current information, via the current sensor, of at least one load of the plurality of loads.
15. The method according to any of the preceding embodiments, further comprising: adjusting the adaptive current threshold in response to the received current information.
16. The method according to any of the preceding embodiments, wherein the current information is a current profile of an active load of the plurality of loads.
17. The method according to any of the preceding embodiments, further comprising: determining at least one of the first current value and the second current value of the adaptive current threshold via the current information.
18. The method according to any of the preceding embodiments, further comprising: providing a power source connected to the pyro switch; selectively connecting at least one of the plurality of loads with the power source via a switching assembly connected between the plurality of loads and the pyro switch.
19. The method according to any of the preceding embodiments, further comprising: detonating a pyro fuse within the pyro switch via the controller to interrupt a current path between the power source and the plurality of loads when the received current information is greater than the adaptive current threshold.
20. The method according to any of the preceding embodiments, wherein the plurality of loads correspond with a plurality of driving modes for an electric vehicle connected with the pyro switch.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples. Uses of “and” and “or” are to be construed broadly (e.g., to be treated as “and/or”). For example and without limitation, uses of “and” do not necessarily require all elements or features listed, and uses of “or” are inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

All matter contained in the above description or shown in the accompanying drawings shall be interpreted as illustrative only and not limiting. Changes in detail or structure may be made without departing from the present disclosure.

It should be understood that a controller, a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

It should be further understood that an article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical system, comprising:
a pyro switch including an adaptive current threshold, the adaptive current threshold adjustable between at least one of a first current value associated with a first driving mode and a second current value associated with a second driving mode;
a controller communicatively connected with the pyro switch; and
a plurality of loads connected with the pyro switch;
wherein the controller is operable to adjust the adaptive current threshold of the pyro switch in response to a sensed driving mode of a load of the plurality of loads.

2. The electrical system of claim 1, wherein the adaptive current threshold of the pyro switch is a current limit of an active load of the plurality of loads.

3. The electrical system of claim 1, further comprising a current sensor connected to the controller and the pyro switch; wherein the controller receives current information from the current sensor.

4. The electrical system of claim 3, wherein the controller determines the adaptive current threshold of the pyro switch via the current information.

5. The electrical system of claim 4, wherein the current information is a current profile of an active load of the plurality of loads.

6. The electrical system of claim 1, wherein the first driving mode is associated with a fast-charging mode.

7. The electrical system of claim 6, wherein the first current value is about 700 A.

8. The electrical system of claim 7, wherein the second driving mode is associated with an air brake mode.

9. The electrical system of claim 8, wherein the second current value is about 350 A.

10. The electrical system of claim 1, further comprising a power source connected with the pyro switch; wherein the power source selectively supplies power to the plurality of loads via the pyro switch operated by the controller.

11. The electrical system of claim 10, further comprising a switch assembly connected between the pyro switch and the plurality of loads; wherein the switch assembly includes at least one switch; and the switch assembly selectively connects at least one load of the plurality of loads with the pyro switch.

12. The electrical system of claim 11, wherein the controller is operable to control the switch assembly; and the controller selectively connects the plurality of loads with the power source.

13. A method of adjusting a current threshold, the method comprising:
providing a pyro switch having an adaptive current threshold;
providing a controller communicatively connected with the pyro switch;
providing a plurality of loads connected with the pyro switch; and
adjusting, via the controller, the adaptive current threshold between at least one of a first current value associated with a first driving mode and a second current value associated with a second driving mode in response to connecting at least one load of the plurality of loads with the pyro switch.

14. The method of claim 13, further comprising:
providing a current sensor connected with the plurality of loads; and
receiving current information, via the current sensor, of at least one load of the plurality of loads.

15. The method of claim 14, further comprising:
adjusting the adaptive current threshold in response to the received current information.

16. The method of claim 15, wherein the current information is a current profile of an active load of the plurality of loads.

17. The method of claim 14, further comprising:
determining at least one of the first current value and the second current value of the adaptive current threshold via the current information.

18. The method of claim 15, further comprising:
providing a power source connected to the pyro switch;
selectively connecting at least one of the plurality of loads with the power source via a switching assembly connected between the plurality of loads and the pyro switch.

19. The method of claim 18, further comprising:
detonating a pyro fuse within the pyro switch via the controller to interrupt a current path between the power source and the plurality of loads when the received current information is greater than the adaptive current threshold.

20. The method of claim 18, wherein the plurality of loads correspond with a plurality of driving modes for an electric vehicle connected with the pyro switch.
